(19) United States
(12) Patent Application Publication
(10) Pub. No.: US 2007/0239354 A1
(43) Pub. Date: Oct. 11, 2007

(54) Method of searching route in navigation system

(75) Inventor: Jin-Pyo Kwon, Ichon-si (KR)

Correspondence Address: STAAS & HALSEY LLP, SUITE 700, 1201 NEW YORK AVENUE, N.W., WASHINGTON, DC, 20005, US

(73) Assignee: HYUNDAI AUTONET CO., LTD., Kyungki-do (KR)

(21) Appl. No.: 11/704,259

(22) Filed: Feb. 9, 2007

(30) Foreign Application Priority Data
Apr. 5, 2006 (KR) 10-2006-0030824

(51) Int. Cl. G01C 21/34

(52) U.S. Cl. 701/210

(57) ABSTRACT

The present invention relates to a method of searching a route in a navigation system, in which a user can reach a destination without passing through set detour regions when a route is searched by allowing the user to set the detour regions in advance, and a route that detours a predetermined range ahead is calculated at the request of a user when delay or restriction is generated ahead. The method includes a first step of allowing a user to set a detour region before a route search is performed, a second step of calculating a detour region link if a destination is set, storing a calculated detour region link and performing the route search, and a third step of comparing a search link with the detour region link during the route search, assigning a distance that can avoid the detour region to a cost if the search link is included in the detour region link, and searching the route. Accordingly, a user can reach a destination without passing through a set detour region.

### BACKGROUND OF THE INVENTION

1. Field of the Invention

The present invention relates generally to a navigation system, and more particularly to a method of searching a route in a navigation system, in which a user can reach a destination without passing through set detour regions when a route is searched by allowing the user to set the detour regions in advance, and a route that detours a predetermined range ahead is calculated at the request of a user when delay or restriction is generated ahead.

2. Background of the Related Art

As the type of a wireless mobile communication service is diversified, wireless mobile communications and a position tracking system are combined with a vehicle. In particular, there is an increasing interest in a telematics service in which a vehicle navigation system for servicing real-time traffic information and guiding traffic information service, remote vehicle diagnosis for informing whether a vehicle is abnormal, vehicle position tracking using GPS, and additional information service for providing a variety of information services are integrated.

The telematics system is included in a vehicle. The telematics system serves as a terminal for receiving various pieces of information and provides a variety of computing functions. The telematics system has a position-based information service of receiving the location of a vehicle from a control center and informing a driver of surrounding information, a remote vehicle diagnosis service of connecting a vehicle's electronic control device, a vehicle diagnosis device and a terminal and transmitting the status of a vehicle to the control center in order to check and control the status of the vehicle, and a navigation service of allowing a driver to provide traffic information up to a desired destination.

Of them, the navigation service will be described below in more detail. In this service, an optimal route from a starting place to a destination is decided at the request of a user and the decided route is provided to a user.

To this end, a navigation server (i.e., an information center) decides a route by employing information about a starting place and destination of a navigation vehicle and current traffic information of a staring time point.

However, if the route from the starting place to the destination is decided using traffic information of the staring time point as described above, a dynamic and real-time route guide cannot be provided because traffic information after a lapse of a traveling time is not taken into consideration. Furthermore, there is a disadvantage in that the accuracy of a predicted arrival time is low due to a possibility that traffic situations may be changed during driving.

To overcome the disadvantage, there was proposed a method of periodically planning a route employing updated traffic information, such as accidents and weather, and changing the route.

Meanwhile, in the conventional navigation system, there is no method of setting additional detour regions. If a user sets a destination, a route from a starting place to a destination is searched unconditionally. The searched route is set and the set route is guided.

Therefore, several problems arise when a route is set because actual road situations are not reflected.

Furthermore, in the conventional navigation system, when a vehicle is deviated from an existing route when delay or restriction occurs ahead while driving the road, a method of inducing research is used. However, at the time of research, a cost policy used before the route search was used without change. Accordingly, there is a disadvantage in that it is difficult to escape a route at which delay or restriction has occurred ahead.

### SUMMARY OF THE INVENTION

Accordingly, the present invention has been made in view of the above problems occurring in the prior art, and it is an object of the present invention to provide a method of searching a route in a navigation system, in which a user can reach a destination without passing through set detour regions when a route is searched by allowing the user to set the detour regions in advance.

Another object of the present invention is to provide the present invention a method of searching a route in a navigation system, in which a route that detours a predetermined range ahead is calculated at the request of a user when delay or restriction is generated ahead.

To achieve the above objects, according to an aspect of the present invention, there is provided a method of searching a route in a navigation system, including a first step of allowing a user to set a detour region before a route search is performed, a second step of calculating a detour region link if a destination is set, storing a calculated detour region link and performing the route search, and a third step of comparing a search link with the detour region link during the route search, assigning a distance that can avoid the detour region to a cost if the search link is included in the detour region link, and searching the route.

In the first step, the detour region is set on a map displayed on the screen in a square shape by a user.

In the second step, the detour region link is calculated by a method of regarding a link formed between nodes inside and outside the detour region as a link included in the detour region.

According to another aspect of the present invention, there is provided a method of searching a route in a navigation system, including a first step of allowing a user to set a detour distance before a route search is performed, a second step of performing the route search if a destination is set, and a third step of comparing a distance from a vehicle location to a link with the detour distance during the route search, if the distance is larger than the detour distance, maintaining an existing cost and if the distance is smaller than the detour distance, newly setting a cost by calculating a link length and a detour region cost, and then performing the route search.

In the third step, when the distance exists within the detour distance, the cost is set in order of a fine road, a general road, a national road and a high-speed road, and when the distance is located outside the detour distance, the cost is set in order of the high-speed road, the national road, the general road and the fine road.

### BRIEF DESCRIPTION OF THE DRAWINGS

Further objects and advantages of the invention can be more fully understood from the following detailed description taken in conjunction with the accompanying drawings in which:

FIG. 1 is a block diagram of a navigation system for a vehicle according to an embodiment of the present invention;

FIG. 2 is a flowchart illustrating a method of searching a route in the navigation system according to an embodiment of the present invention;

FIG. 3 is a flowchart illustrating a method of searching a route in the navigation system according to another embodiment of the present invention; and

FIG. 4 is a view illustrating that a detour region set by a user is displayed on the screen.

### DETAILED DESCRIPTION OF THE PREFERRED EMBODIMENT

The present invention will now be described in detail in connection with specific embodiments with reference to the accompanying drawings.

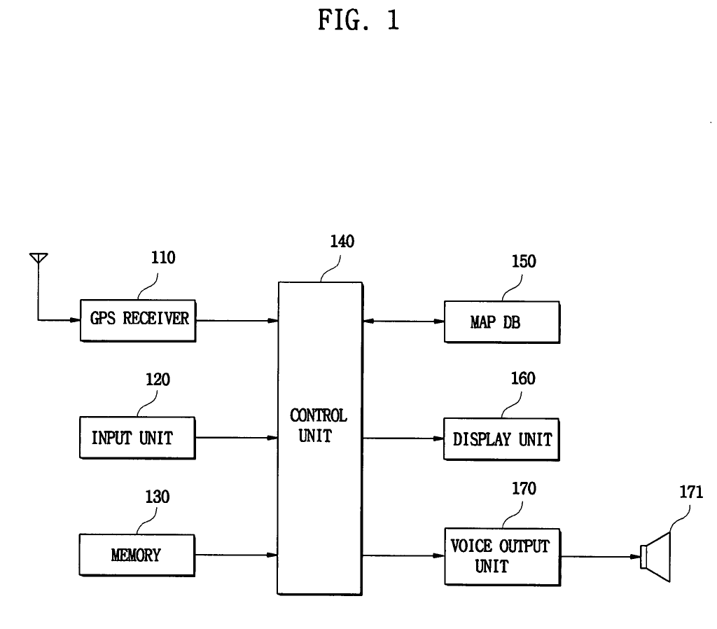

FIG. 1 is a block diagram of a navigation system for a vehicle according to an embodiment of the present invention.

In FIG. 1, reference numeral 110 indicates a GPS receiver for receiving positional information transmitted from a GPS satellite and a vehicle's traveling velocity. The GPS receiver 110 includes a GPS antenna, etc. and also receives positional information, such as a location and an angle, from the GPS satellite.

Reference numeral 120 indicates an input unit, such as a touch screen or a keypad, for generating a user manipulation signal depending on the manipulation of a user. A detour region and a detour distance can be set using the input unit. In general, the input unit 120 may include a keypad device, such as a keyboard, for user manipulation, but may be operated in conjunction with a display device when it includes a touch screen.

Reference numeral 130 indicates memory for storing therein an application program for operating the navigation system, detour regions and detour distances, which are set by a user, and so on.

Reference numeral 140 indicates a control unit for controlling an overall operation of the navigation system. The control unit allows a user to reach a destination by searching a route without passing through a detour region according to a detour region or a detour distance set by a user. The control unit 140 may be a general central processing unit (CPU) or microprocessor.

Reference numeral 150 indicates a map database (DB) for outputting map information of a road system. Reference numeral 160 indicates a display unit for displaying thereon a starting place, a destination, an ongoing route, traffic information, parking lot positional information, road information, representative facilities, surrounding information and so on under the control of the control unit 140.

Reference numeral 170 indicates a voice output unit for outputting necessary voice through a speaker 171 at the time of route setting and guide.

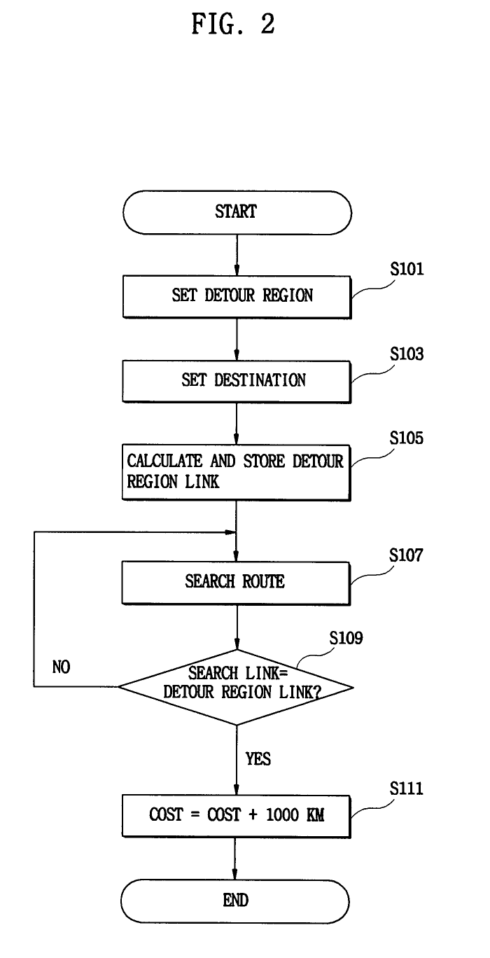

FIG. 2 is a flowchart illustrating a method of searching a route in the navigation system according to an embodiment of the present invention.

Referring to FIG. 2, the method according to an embodiment of the present invention includes a first step S101 of allowing a user to set a detour region before a route search is performed, a second step S103 to S107 of calculating a detour region link if a destination is set, storing a calculated detour region link and searching a route, and a third step S109 to S111 of comparing a search link with the detour region link during the route search, if the search link is included in the detour region link, assigning a distance that can avoid the detour region to a cost, and searching a route.

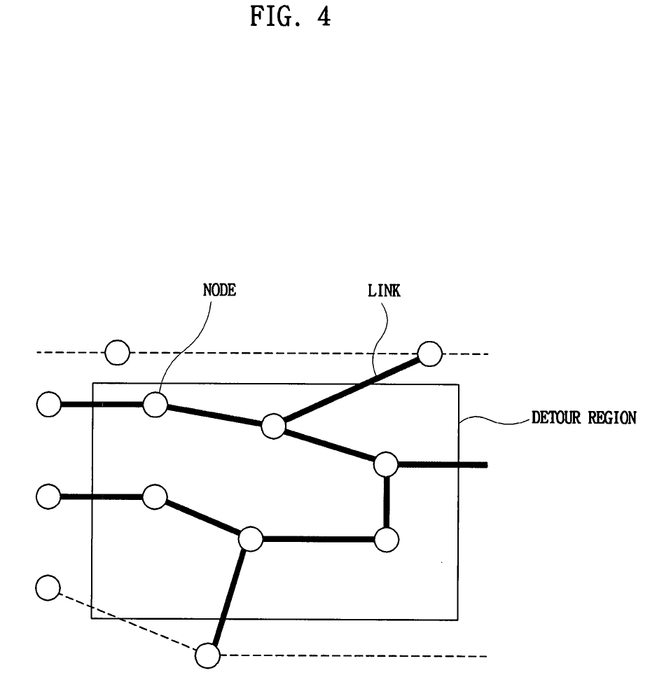

In the route search method of the navigation system according to an embodiment of the present invention, a user can set a detour region on a map displaying the detour region in a square fashion using the input unit 120 at step S101. In this case, it is preferred that a user set the detour region on a map displayed on the screen in a square shape. FIG. 4 is a view illustrating that a detour region set by a user is displayed on the screen. There is shown in FIG. 4 the detour region of the square shape, a plurality of nodes included in the detour region, and links formed between neighboring nodes.

If a destination is set at step S103, the control unit 140 calculates a detour region link and stores a calculated detour region link in the memory 130 at step S105.

In this case, if the detour region set by the user and the line of a link cross each other, that is, if a link formed by a first node inside the detour region and a second node outside the detour region crosses a line partitioning the detour region as shown in FIG. 4, the detour region link is calculated by a method of regarding the link as a link included in the detour region.

A route is then searched at step S107. The search link and the calculated and stored detour region link are compared with each other at step S107. If the search link belongs to the detour region link as a result of the comparison, a predetermined distance, for example, 1000 km is added to the cost at step S111, so that the detour region link can be avoided.

In other words, in the present embodiment, a user can directly designate a detour region to map and traffic situations on which actual road situations have not been reflected. Accordingly, a route can be searched so that a user can reach a destination without passing through a detour region at the time of route search.

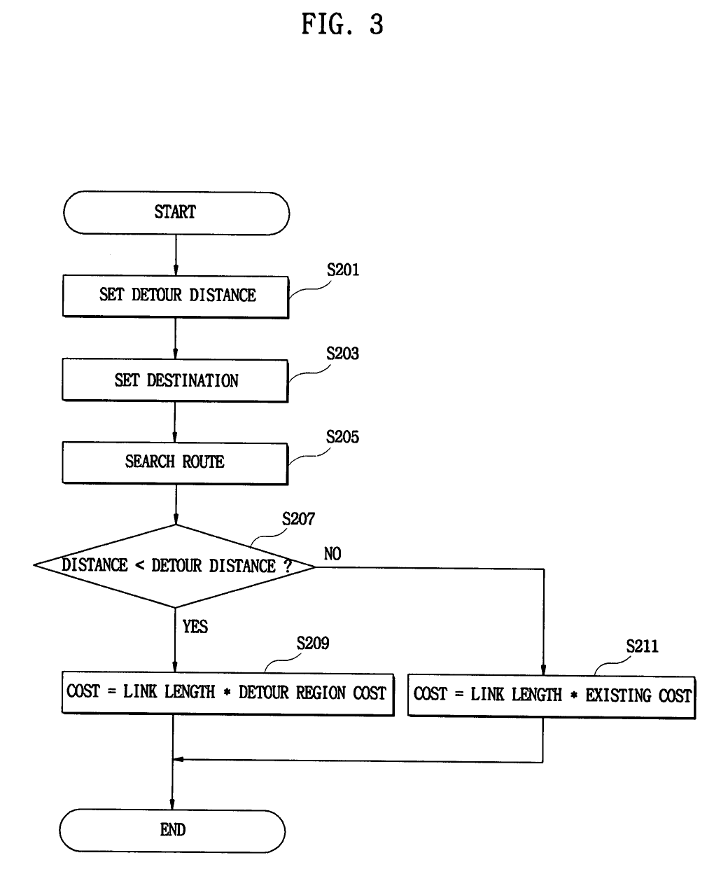

FIG. 3 is a flowchart illustrating a method of searching a route in the navigation system according to another embodiment of the present invention.

Referring to FIG. 3, the method according to another embodiment of the present invention includes a first step S201 of allowing a user to set a detour distance before a route search is performed, a second step S203 and S205 of performing the route search if a destination is set, and a third step S207 to S211 of comparing a distance from a vehicle location to a link with the detour distance during the route search, and if the distance is larger than the detour distance, maintaining an existing cost and if the distance is smaller than the detour distance, newly setting a cost by calculating a link length and a detour region cost, and then performing the route search.

In the present embodiment, a user sets a detour distance using the input unit 120 at step S201. The detour distance is for the purpose of searching a route that detours a corresponding distance at the request of a user when delay or restriction has occurred ahead.

If a destination is set at step S203, the control unit 140 searches a route at step S205 and compares a distance from a current location of a vehicle to a link and the detour distance set by the user at step S207. If the distance exists within the detour distance as a result of the comparison, the process proceeds to step S209 in which the cost is set in order of a fine road, a general road, a national road and a high-speed road. If the distance is deviated from the detour distance, the proceeds to step S211 in which the cost is set in order of the high-speed road, the national road, the general road and the fine road.

In other words, when a vehicle is located on a route at which delay or restriction has occurred, the cost is set contrary to the cost policy of an existing search so that a user can detour a predetermined distance (several km) ahead without following an existing cost policy.

As described above, in accordance with the route search method of the navigation system according to the present invention, a user can set a detour region in advance. Accordingly, there is an advantage in that a route can be searched so that a user can reach a destination without passing through a set detour region at the time of route search.

Furthermore, when delay or restriction has occurred ahead, a route that detours a predetermined range ahead is calculated at the request of a user. Accordingly, there is an advantage in that a route at which delay or restriction has occurred can be avoided.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

What is claimed is:

1. A method of searching a route in a navigation system, the method comprising:
a first step of allowing a user to set a detour region before a route search is performed;
a second step of calculating a detour region link if a destination is set, storing a calculated detour region link and performing the route search; and
a third step of comparing a search link with the detour region link during the route search, assigning a distance that can avoid the detour region to a cost if the search link is included in the detour region link, and searching the route.

2. The method of claim 1, wherein in the first step, the detour region is set on a map displayed on the screen in a square shape by a user.

3. The method of claim 1, wherein in the second step, the detour region link is calculated by a method of regarding a link formed between nodes inside and outside the detour region as a link included in the detour region.

4. A method of searching a route in a navigation system, the method comprising:
a first step of allowing a user to set a detour distance before a route search is performed;
a second step of performing the route search if a destination is set; and
a third step of comparing a distance from a vehicle location to a link with the detour distance during the route search, if the distance is larger than the detour distance, maintaining an existing cost and if the distance is smaller than the detour distance, newly setting a cost by calculating a link length and a detour region cost, and then performing the route search.

5. The method of claim 4, wherein in the third step, when the distance exists within the detour distance, the cost is set in the order of a fine road, a general road, a national road and a high-speed road, and when the distance is located outside the detour distance, the cost is set in the order of the high-speed road, the national road, the general road and the fine road.
